(19) United States
(12) Patent Application Publication
(10) Pub. No.: US 2009/0284709 A1
(43) Pub. Date: Nov. 19, 2009

(54) Eyeglass Holder

(76) Inventor: Joanne M. Didner, Egypt, TX (US)

Correspondence Address: MICHELLE L. DOBRAWSKY, 63 AVENUE A, SUITE 16E, NEW YORK, NY, 10009, US

(21) Appl. No.: 11/682,911

(22) Filed: May 15, 2008

(51) Int. Cl. G02C 5/14; G02C 3/00; A45F 5/00

(52) U.S. Cl. 351/112; 351/155; 24/3.3

(57) ABSTRACT

This disclosure is directed to an eyeglass holder arranged to be worn on ones' clothing and includes a cylindrical or rectangular base containing a semicircular ring fixedly attached, through which a smaller loop is threaded, and, through such smaller loop a larger ring is threaded, said larger ring being able to attach to the temple bar of a pair of eyeglasses. The free rotation of the rings through each other and through the semicircular loop fixed to the base member allow for the eyeglasses to lie flat against a user's garment, employing a buttonhole on said garment, and thus be safely and reversibly attached to said garment.

### FIELD OF THE INVENTION

This invention related to eyeglass holders, specifically to a personal eyeglass holder that can be readily attached to ones' clothing via a buttonhole.

### BACKGROUND OF THE INVENTION

Eyeglass holders conventionally consist of a case or pouch, meant to be carried in a pocket or purse. Other eyeglass holders employ a cord or necklace, attached to the eyeglass frame's earpiece via looped ends, to be worn around the user's neck, from which eyeglasses may swing freely. A third class of eyeglass holders, broadly, consists of devices designed to more securely fix the eyeglasses to the user's clothing by various means of attachment to the eyeglass frame and to the user's clothing. While each type has its advantages and disadvantages, the invention herein belongs to the third category—eyeglass holders which attach to users' clothing, and represents an improvement over existing holders of this type.

Each of the designs below has specific disadvantages which are addressed by the invention herein.

Moennig, U.S. Pat. No. 5,956,812 depicts a flexible strand connected to a spring-loaded “alligator clip.” This type of clip has toothed jaws and cannot be attached to delicate fabrics without causing tearing or damage due to the teeth of the clamp and the weight of the glasses pulling downward.

Kraut, U.S. Pat. No. 6,076,925 describes a holder utilizing a spring-loaded clip that can be fixed to the edge of a user's garment; however, this clip employs serrated teeth which can still damage fabric.

Resendez, Sr., U.S. Pat. No. 6,045,221 described a spectacle clip for attaching eyeglasses to a user's garment. However, this invention requires that the clip be integral to the glasses themselves, or attached to the user's eyeglasses by means of a special kit.

Thus, this clip is unique in that it contains features that serve the dual purposes of protecting the garment and safely securing the eyeglasses when not in use. It employs a buttonhole already existing on the garment and can support the weight of the eyeglasses, and allows the eyeglasses to lie flat and not dangle freely. It serves the purposes of not damaging fabric, accommodating a wide range of eyeglasses and a wide range of fabrics and protecting both the user's garment and eyeglasses. Finally, it can be easily attached and removed and used on any pair of user's eyeglasses.

Accordingly, there exists a need to provide for a simplified and versatile type of eyeglass holder which provides a safe and secure means of holding the eyeglasses when not in use, allowing the eyeglasses to lie flat against the user's body, preventing damage to both the user's eyeglasses and clothing.

### SUMMARY OF THE INVENTION

An object of this invention is to provide a personal eyeglass holder which provides a secure means of support and connection between the user's eyeglasses and the user's clothing. The invention should cause the eyeglasses to lie flat against the user's clothing, providing a safe and secure location for the eyeglasses when not in use. Another object is to provide an eyeglass holder which attaches to the user's garment via a buttonhole, thus avoiding damage to the garment itself. Another object is to provide an eyeglass holder which can be worn on many different types of garments. Finally, the eyeglass holder should be simple in construction, positive in operation, and inexpensive to manufacture.

The foregoing objects and other features and advantages are attained by an eyeglass holder having a looped end which rotates freely through a smaller ring, which in turn rotates freely through a fixed semicircular ring attached fixedly to a base member of either cylindrical or rectangular shape.

Such free rotation allows the base member to lie flat against the user's garment from the inside, while the eyeglasses lie flat against the outside of the user's garment, at a right angle to the base member which remains inside the wearer's garment, facing the wearer's body. The size and shape of the base member allow it to be inserted, at an angle, through a buttonhole, but not be pulled back through the buttonhole when the device is in use.

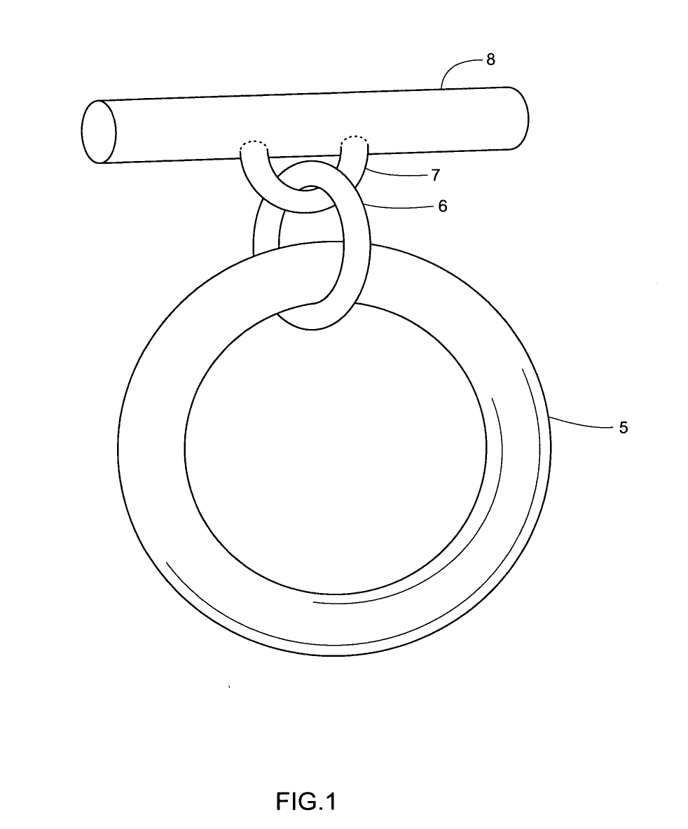

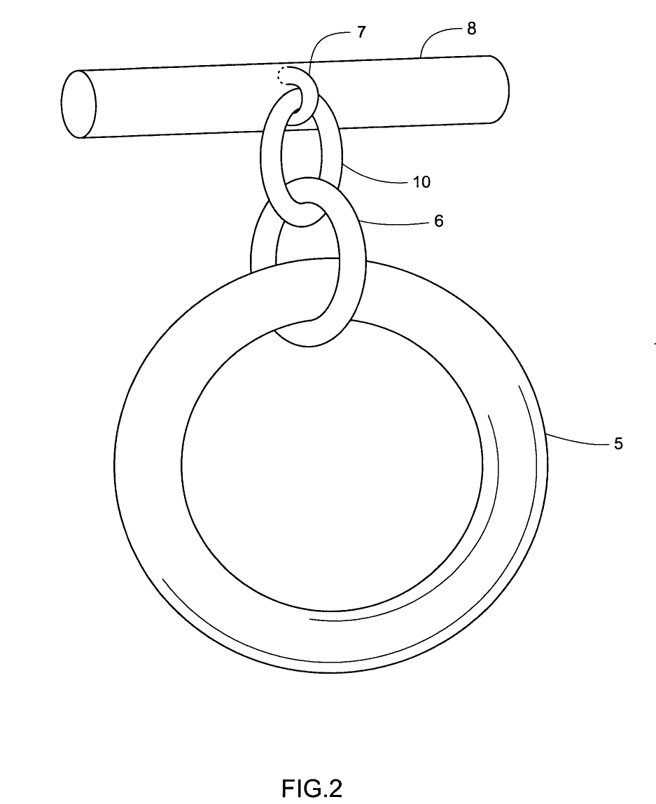

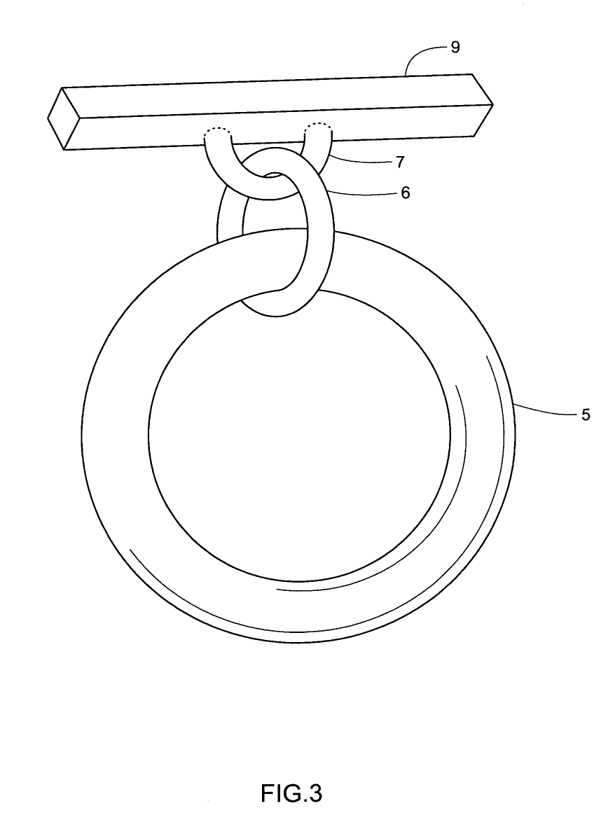

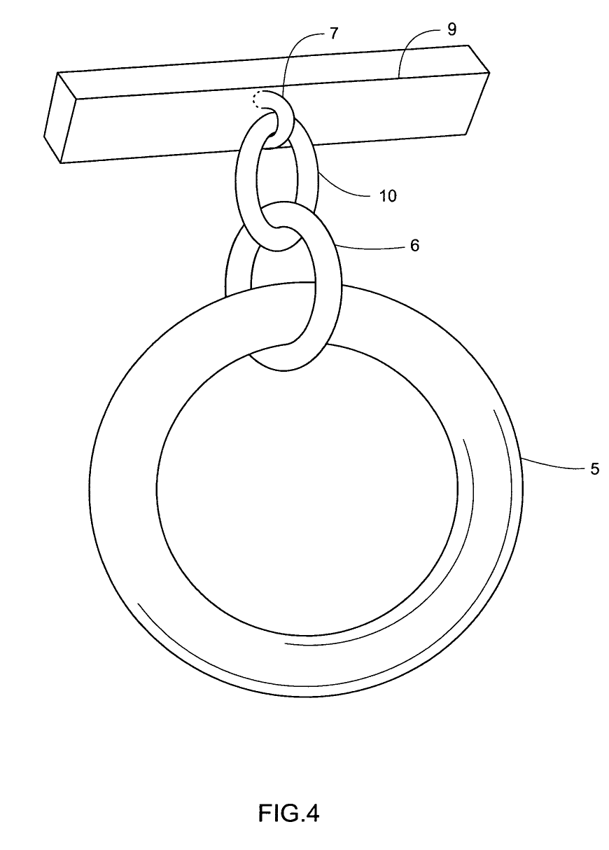

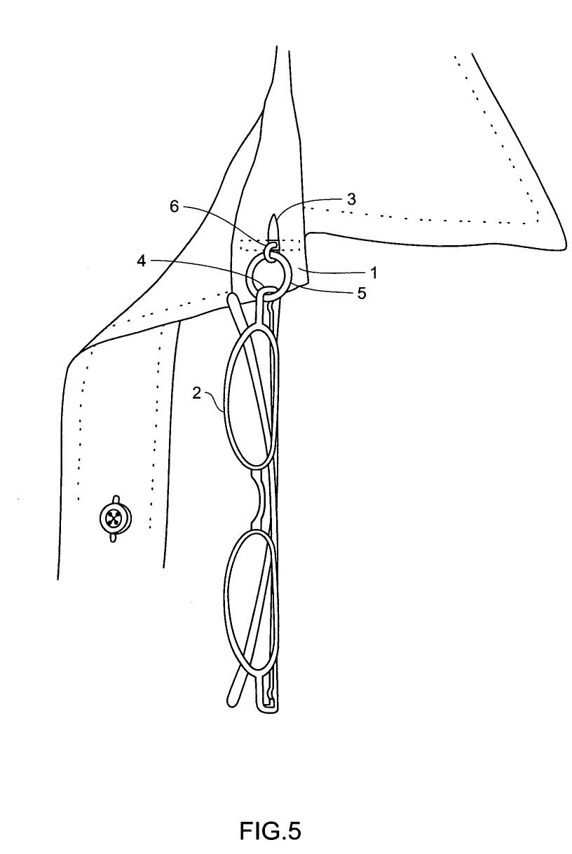

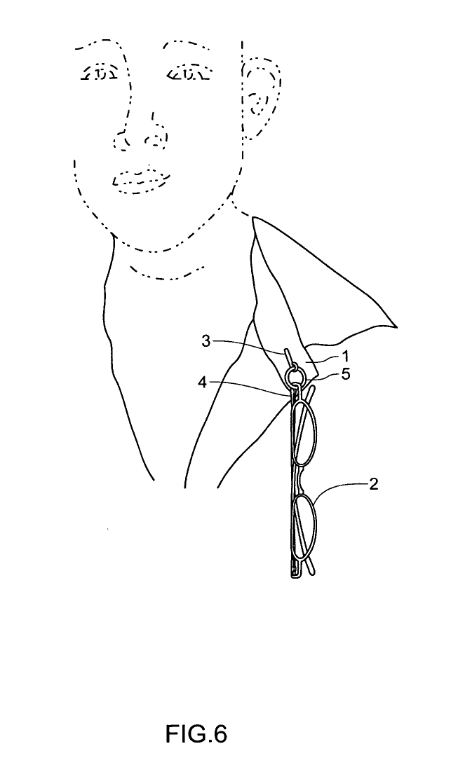

The drawings herein represent the design of the invention as well as examples of the invention in use. FIGS. 1-4 represent the invention itself, while FIGS. 5 and 6 demonstrate the way in which the invention safely and securely attaches eyeglasses to the user's garment.

Thus, this holder is unique in that it contains features that serve dual purposes of protecting the garment and securing the eyeglasses when not in use. It employs a buttonhole already existing on the garment and can support the weight of the eyeglasses, and allows the eyeglasses to lie flat and not dangle freely. It serves the purposes of not damaging fabric, accommodating a wide range of eyeglasses and a wide range of fabrics and protecting both the user's garment and eyeglasses. Finally, it can be easily attached and removed and used on any pair of user's eyeglasses.

### DESCRIPTION OF THE PREFERRED EMBODIMENT

Referring now to the drawing, an eyeglass holder shown at (1) is used to secure a pair of eyeglasses shown at (2) to the buttonhole of a shirt (3) when the eyeglasses are folded and not being worn. The eyeglasses include a temple bar (4). The eyeglass holder comprises a rigid or flexible ring (5) through which the temple bar is inserted, to secure the holder to the eyeglasses.

The large ring is then threaded through a smaller ring (6), where such large ring can move freely. The smaller ring is then threaded through a semicircular ring (7) fixedly attached to a flat member (8).

Such flat base member may be comprised of a cylindrical member (in which case the semicircular ring is fixed to a central point on the exterior surface) or a rectangular member (in which case the semicircular ring is fixed to a central point on the longer faces of the exterior surface).

In either case, the base member is slightly longer than a buttonhole, and is designed to be inserted through the buttonhole at an angle, and then lie flat against the inside of the user's garment (without slipping through same). The small loop is able to pass through the buttonhole, and the rotation of the loops allow the eyeglasses to lie flat, at (or near) a right angle to the small loop and parallel to the base member. The eyeglasses are thus held securely in place against the user's garment, hanging straight downward.

Materials for the production of the invention can be metal, plastic, rubber or a combination thereof, and the entire apparatus can be comprised of a single material or a combination of said materials.

Thus, as shown above, the eyeglass holder as described is simple and positive in its operation. It allows the wearer to easily secure and protect her eyeglasses from damage and loss; it can be fixed to any type of clothing having a buttonhole without risking damage to clothing; it can be easily attached to and removed from any pair of eyeglasses, making it a useful and versatile accessory. Moreover, it is simple and elegant in design, and can be manufactured in a variety of materials.

While the preferred embodiments have been set forth as described above, such descriptions are to serve as examples only. Various details of design and construction may be modified without departing from the spirit or scope of the invention as set forth in the following claims.

What is claimed is:

1. A personal holder comprising:
base member, comprised of a cylindrical bar having an outer surface;
a semicircular raised member, fixedly attached about the center point measured in the longitudinal direction of said outer surface of the base member;
a small closed ring threaded through the inner surface of the semicircular raised member, at a perpendicular angle relative to the base member and freely rotating along its circumference through the semicircular raised member;
a large closed ring threaded through the inner ring of the small closed ring, at a perpendicular angle relative to the small closed ring, rotating freely along its circumference through the small closed ring and lying flat and parallel relative to the base member.

2. The invention of claim 1, where the base member is comprised of a rectangular bar having an inner and outer surface, where said outer surface contains four long sides upon which the semicircular raised member can be fixedly attached to a center point measured in the longitudinal direction on one of the sides.

3. The invention of claim 1, where there are a variable number of additional small closed rings are threaded through each other, forming a chain of variable length between the circular member and base member.

4. The invention of claim 1 in which the personal holder is employed as an eyeglass holder for supporting the eyeglasses flat against the wearer's clothing when not in use.
